(19) United States
(12) Patent Application Publication
(10) Pub. No.: US 2002/0106490 A1
(43) Pub. Date: Aug. 8, 2002

(54) Lightweight composite article

(76) Inventor: Joachim Wagenblast, Hong Kong (HK)

Correspondence Address: BAYER CORPORATION, PATENT DEPARTMENT, 100 BAYER ROAD, PITTSBURGH, PA, 15205, US

(21) Appl. No.: 10/041,806

(22) Filed: Jan. 7, 2002

(30) Foreign Application Priority Data
Jan. 11, 2001 (DE) 10100914.3

(51) Int. Cl. B32B 3/30

(52) U.S. Cl. 428/180

(57) ABSTRACT

A lightweight composite article is described. The lightweight composite article comprises: (a) two substantially opposed plates, at least one of the plates is a metal plate; and (b) a support structure of thermoplastic material interposed between the plates, the support structure defining a plurality of hollow spaces. Each of the plates (a) is fixedly attached to the support structure (b) by means of a plurality of anchors, which are distributed substantially uniformly over the surface of each of the plates. The support structure may be in the form of a ribbed support structure and/or an egg-box shaped support structure. Also described are articles of manufacture which comprise the lightweight composite article of the present invention, e.g., automotive components.

### CROSS REFERENCE TO RELATED PATENT APPLICATION

The present patent application claims the right of priority under 35 U.S.C. 119 (a)-(d) of German Patent Application No. 101 00 914.3, filed Jan. 11, 2001.

### DESCRIPTION OF THE INVENTION

The present invention relates to three-dimensionally bowed or plane plate-shaped lightweight articles of composite construction. The composite articles include a support structure of shaped thermoplastic material (e.g., a thermoplastic “egg-box structure” and/or a thermoplastic ribbed structure having a plurality of rubs), and two substantially opposed plates, one of which is metal, fixedly attached to the ribbed support structure. The invention also relates to rigid and torsion-resistant plate-shaped lightweight parts of hybrid construction.

The plate-shaped lightweight part comprises of a high-strength and high-rigidity component, such as steel or composites, which is supported by means of a thermoplastic egg-box structure or a thermoplastic extruded section.

Low-weight sections and plates with high load-bearing capacity are frequently constructed as a sandwich of a foam or a honeycomb structure being fitted between metal or composite plates by incorporation into the material (Pippert, Karosserietechnik, 2nd edition, Vogel Buchverlag, Würzburg, 1992). In addition, there are processes for producing composite plates with external sheets and internal ribbed structure (EP 0 775 573 A2). There are furthermore described in, for example, EP 370 342 A2 plastic/metal composite parts which consist of metal sheet structures supported by plastic ribs.

Said plate-shaped lightweight parts prevalent in practice have either the disadvantage, as in the case of sandwich plates, that the bond between outer skin and core is not positive, or, as in the case of ribbed lightweight components, that the latter, if they are produced discontinuously, are fabricated with a complex technology.

Conventional sandwich structures exhibit a joint between the outer skin and the core, or between the high-strength component and the lightweight structure (e.g., foam, ribbed or honeycomb structure), which is material-incorporated and/or non-positive. Consequently the shear strength of the composite is dependent on the quality of the joint. The following influencing factors are of importance here: material pairing, surface condition (e.g., cleanness, roughness), and in the case of bonded connections the physical properties of the adhesive. In addition, the quality of the composite can be influenced to a large extent by the prevailing environment.

Lightweight parts consisting of high-strength components such as metal sheets and a ribbed structure of thermoplastic material supporting the latter are produced in a discontinuous method of manufacture by sheet shaping with a subsequent injection molding process (EP 370 342 A2). Such a method of manufacture typically entails high mold and machine costs, so that it is worthwhile for the most part only with the operation of long runs, such as are encountered e.g. in the automotive industry. In a continuous method of manufacture by means of extrusion (e.g., as described in EP 0 775 573 A2) the manufacturing costs can admittedly be kept low also with smaller production runs. This advantage is however offset by the disadvantage that the functionality of the lightweight parts is then restricted or the cost of re-working is high.

The object of the invention therefore relates to creating plate-shaped lightweight parts of the kind mentioned previously herein in the introduction, which have both high-strength and high-rigidity and can be manufactured by means of an economic method of production.

This object is achieved according to the invention by means of a composite which includes a high-strength component and a thermoplastic ribbed structure, that are joined to one another to form a lightweight article.

In accordance with the present invention, there is provided a lightweight composite article comprising:

(a) two substantially opposed plates, at least one of said plates is a metal plate; and

(b) a support structure of thermoplastic material interposed between said plates, said support structure defining a plurality of hollow spaces,

wherein each of said plates is fixedly attached to said support structure by means of a plurality of anchors, said anchors being distributed substantially uniformly over the surface of each of said plates.

The features that characterize the present invention are pointed out with particularity in the claims, which are annexed to and form a part of this disclosure. These and other features of the invention, its operating advantages and the specific objects obtained by its use will be more fully understood from the following detailed description and the accompanying drawings in which preferred embodiments of the invention are illustrated and described.

Other than in the operating examples, or where otherwise indicated, all numbers or expressions, such a those expressing structural dimensions, injection conditions, etc, used in the specification and claims are to be under stood as modified in all instance by the term “about.”

### BRIEF DESCRIPTION OF THE DRAWINGS

FIG. 1 is a perspective view of a sectional representation of a lightweight composite article of the present invention;

FIG. 1a is an representative detailed view of an edge region of the lightweight composite article of FIG. 1;

FIG. 2 is sectional representation of a lightweight composite article of the present invention which further comprises a textile layer;

FIG. 3 is a sectional representation of a lightweight composite article of the present invention in which the hollow spaces of the ribbed support structure are filled with a foam;

FIG. 4 is a sectional representation of a lightweight composite article of the present invention in which the hollow spaces of the ribbed support structure are filled with a foam;

FIG. 5 is a perspective view of support structures having two different egg-box configurations; and

FIGS. 6 through 11 are sectional representations of lightweight composite articles according to the present invention in which various anchors are illustrated.

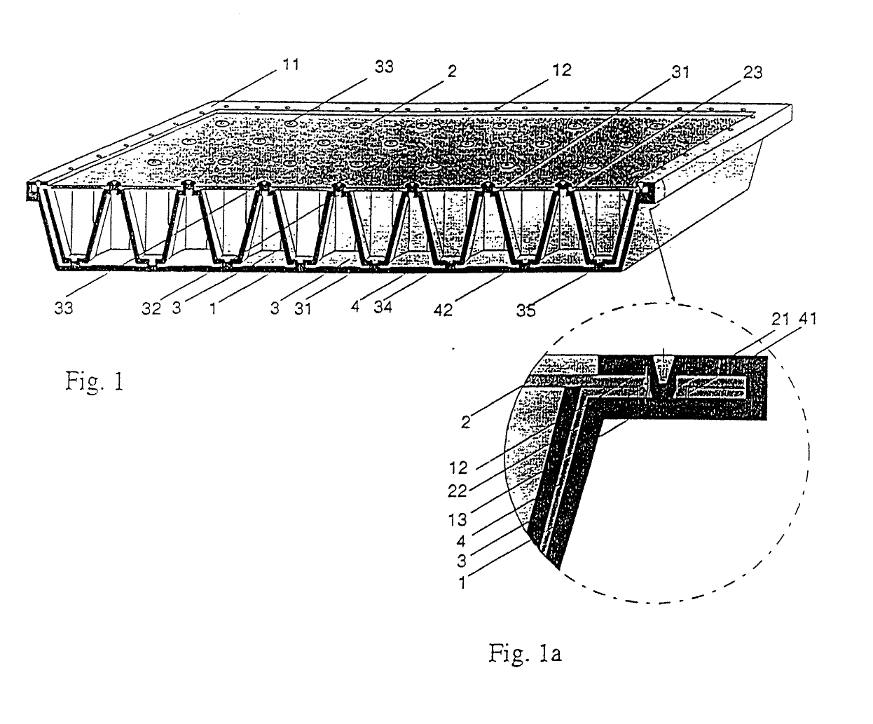

Unless otherwise noted, in FIGS. 1 through 11, like reference numerals and characters designate the same components and structural features.

### DETAILED DESCRIPTION OF THE INVENTION

Preferably the supporting structure is substantially symmetrical, e.g., of a mirror-symmetrical construction viewed in at least two directions of the plane of the substantially opposed plates. In this embodiment, the lightweight composite article has high rigidity both in the transverse and in the longitudinal directions. In a preferred embodiment, the support structure is a substantially continuous support structure.

In an embodiment of the present invention, at least a portion of the hollow spaces of the support structure, e.g., one side of a hollow spaces of an egg-box support structure, are filled with a foam.

In a particularly preferred embodiment of the invention, the anchors comprise openings, recesses and/or nubs. More particularly, the anchors are formed from: (i) each of the plates having a plurality of at least one of perforations and recesses, and the support structure having a plurality of joining elements (e.g., rivets or more particularly rivet shafts) extending therefrom, at least some of which extend through at least some of the perforations and into at least some of the recesses, thereby anchoring each of the plates to said support structure. Alternatively, the anchors may also be formed by (ii) the support structure having a plurality of at least one of perforations and recesses, and each of the plates having a plurality of joining elements extending therefrom, at least some these joining elements extending through at least some of the perforations and into at least some of the recesses of the support structure, thereby anchoring each of the plates to the support structure. Further alternatively, the anchors may comprise (iii) a combination of (i) and (ii).

The thermoplastic material of the support structure (b) may be a non-reinforced or reinforced or an unfilled or filled thermoplastic material. The thermoplastic material of support structure (b) is particularly preferably selected from at least one of polyamide, polyester, poylolefin, styrene copolymer, polycarbonate, polyphenylene oxide, polyphenylene sulfide, polyimide, polyvinyl chloride, thermoplastic polyurethane, PSO and PEEK.

The metal of the metal plate is preferably selected from at least one of steel, aluminum, magnesium, and an alloy of these metals with other metals. The other plate is preferably a fibre/plastic composite, e.g., a fiber/thermoplastic composite where the thermoplastic material may be selected from those recited previously herein with regard to the support structure.

The plates (a) are connected positively in the form of a plate, panel or film to the thermoplastic support structure (b). To this end openings are preferably created in the plates, through which the thermoplastic melt flows during the shaping process of the support structure (forming rivet shafts therethrough), and also forming rivet heads on the other, e.g., rear, side due to matching configurations within the shaping molds.

The typical layer thickness of the plates (a) is from 0.1 to 2.5 mm.

In this way two or more plates (e.g., high-strength metal plates or components) arranged directly above one another may also be connected to congruent openings. The plates may further also be connected to one another by form closures in such a way that the force transmission may take place directly from one plate to another. The rivets of plastics material then simply hold the plates together and protect the composite material.

If the plates, e.g., high-strength components, are connected to one another only in their edge region (e.g., by means of crimping), hollow chamber structures with high load-bearing capacity may be created. The edge region is then reinforced through two or more layers and connected positively, while inside the edge region the high-strength components are held apart by ribs of plastics material. A thermoplastic material may be interposed between the plates in the crimped edge region.

In addition, there is the possibility of creating lightweight composite articles according to the present invention which comprise a plurality of plates connected directly to one another, which are likewise joined by means of rivets of plastics material, wherein the component of plastics material however also forms, as integrally molded thermoplastic plates, a cover or jacketing of the lightweight composite article. The cover or jacketing of the lightweight composite article part may further also take the form of integrally molded or joined-on foams or textiles.

A further method of bringing about the positive connection between support structure (b) and plates (a), e.g., high-strength components, is the incorporation of beads, depressions or nubs into the plates. The thermoplastic ribbed structure will then likewise be fashioned by shaping processes in such a way that it forms positive connection elements with the plates.

In the production of the lightweight composite article, first the plates or high-strength components are punched out, sawn out or cut out and the openings and/or beads, depressions or nubs formed. If the lightweight composite article is to be constructed in a bowed shape, the high-strength component must undergo a suitable shaping process (in the case of metal sheets by deep drawing).

The thermoplastic support structure is manufactured in a second step. In the preferred embodiment an egg-box structure is formed in plane or bowed alignment by thermoforming from a thermoplastic film precursor.

In the case of an egg-box shaped support structure, the shaping process for producing the egg-box structure may be utilised simultaneously for joining the individual components. To this end, the high-strength components are introduced into the mold. The thermoplastic film precursor is heated and shaped, due, for example, to an applied vacuum, through the openings or into the depressions or via the nubs of the high-strength component.

The ribbed structure may however also be produced by extrusion of a corresponding hollow section, which is then cut to the required size.

If the ribbed structure is produced separately by extrusion of such a hollow section, positively locking elements may be integrally molded with the ribbed structure with the aid of the high-strength components. This takes place in a thermal shaping process, in which the high-strength component serves as a mold. The high-strength component is here connected directly to the ribbed structure and may be reinforced optionally by bonding, welding, screwing, catching or a combination of said joining methods. A further possibility is the creation of openings in the hollow section representing the ribbed structure. Congruently arranged nubs of the high-strength component project into said openings and thus produce a positive closure between ribbed structure and high-strength component.

The extruded sections may be connected to the high-strength component both longitudinally (top side or underside of the section) and obliquely (plane of section) relative to the extrusion direction. If the extrusion sections are connected to the high-strength components obliquely relative to the extrusion direction, screwing or welding domes may be molded integrally, by means of which a connection to the high-strength component may be achieved.

The composite article may also be produced by the punctiform welding of two thermoplastic components. In this case two or more thermoplastic components incorporate one or more high-strength components. The weld points are so arranged that they lie in the openings of the high-strength components. In this way the high-strength component is clamped between the two thermoplastic components and fixed positively.

The welding of two thermoplastic components or plates with a high-strength component or plate lying between them may also be combined with the thermoforming for producing the egg-box structure. In this case the egg-box structure is first of all shaped and then welded to a second thermoplastic component directly after the shaping operation, by means of corresponding male molds.

A further variant is possible if the high-strength components consist of woven or non-woven fabric reinforced composites with thermoplastic matrix. In this case high-strength component and thermoplastic ribbed structure may be welded directly to one another.

The invention further provides articles of manufacture that comprise the lightweight composite article of the present invention. Such articles of manufacture include, but are not limited to, a construction element in the automotive industry, in particular for the underbody, covers for spare wheel recess or trunk, or for the roof assembly, in particular self-supporting roof assemblies, and also washing machine lids or housings for refrigerators.

The advantages that may be provided by the lightweight composite article of the present invention include the following. The composite articles can provide a combination of high-strength and high-rigidity in a bowed or plane configuration. The composite articles can be in the form of sandwich structures having high shear strength. The composite articles can be in the form of sandwich structures having defined hollow spaces, e.g. for accommodating cables. The anchors of the composite articles can be largely independent of the material pairing due to positive joining resulting therefrom. The lightweight composite articles of the present invention are substantially free of sudden failures due to separation of the end layers. The lightweight composite articles of the present invention can be prepared by means of low-cost fabrication processes, including small run cost fabrication processes. Production of the lightweight composite articles of the present invention typically involves low tooling costs.

The invention will be described in further detail with reference to the drawing figures, without limitation of the invention thereby.

### EXAMPLES

Hollow chamber-lightweight part with internal egg-box structure FIGS. 1 to 11

FIGS. 1 to 11 represent embodiments of hollow-chamber lightweight composite articles of the present invention having internal egg-box support structures.

FIG. 1 shows the cut-away hollow chamber-lightweight part, which is composed of the metal sheets 2 and 4 and of the thermoplastic plastic plate 1 and the ribbed structure 3 formed in the shape of an egg-box. Plastic plate 1 incorporates in the edge region 11 two metal sheets 2 and 4. As can be seen in the detail view (FIG. 1a), the metal sheets 2 and 4 are connected to one another, via the plastics plate 1 flanged in the edge region 11 below the depressions 12, by the weld points 13 in the congruent openings 21 and 41 of the metal plates 2 and 4. The two metal plates 2 and 4 are in addition connected positively by the bead 22 in the opening 21 of the metal sheet 2, which bead 22 projects into the opening 41 of the metal plate 4.

The metal plates 2 and 4 are supported by the egg-box-shaped supporting structure (egg-box structure) 3 via the parallel contact surfaces 31 of the egg-box structure 3. Metal plate 2 is connected to the egg-box structure 3 via the rivet heads 33. The connection between plastic plate 1 and egg-box structure 3 is realised by the weld points 35. Since the weld points 35 are located in the openings 42 of the metal sheet 4 and since metal sheet 4 is in addition arranged between plastic plate 1 and egg-box structure 3, the additional fixing of metal plate 4 may also be achieved by the connecting of plastic plate 1 and egg-box structure 3.

The manufacture of the lightweight part represented in FIG. 1 is carried out by means of a multi-stage shaping and welding process. Accordingly the metal plates 2 and 4 are first of all punched and deep-drawn, and the plastic plate 1 and the egg-box structure 3 thermoformed out of a plane plate. Metal plate 4 and egg-box structure 3 are then placed in plastic plate 1. Plastic plate 1 and egg-box structure 3 are thereupon welded together by ultrasonic welding at the weld points 35. Metal plate 2 is now laid on the egg-box structure 3, so that the rivet heads 33 not yet shaped project through the openings 21 of the metal plate 2 and the beads 22 of metal plate 2 project through the openings 41 of plate 4. Finally, the not yet shaped rivet heads 33 of the egg-box structure 3 and the not yet produced weld points 13 in the edge area 11 of the plastic plate 1 are shaped to their definitive form in a thermal shaping process. For this in particular the plastic plate I is heated in the edge area 11 and crimped over by means of a suitable tool. The weld points 13 are attached with the aid of heated mandrels via the depressions 12. The shaping of the rivet heads 33 is also carried out with heated mandrels.

FIG. 2 shows a section through a sandwich structure according to FIG. 1, which has been modified in certain areas. The lightweight part according to FIG. 2 consists of the metal plates 2 and 4, which are kept apart by the egg-box structure 3. The plastic plates 1 and 5 enclose the metal plates 2 and 4. Plastic plate 5 is furthermore provided with a textile layer 7. Here the plastic components 1, 3 and 5 are welded or bonded to one another at the connection points 6 and 35. The connection points 6 and 35 are likewise located in the openings 21 and 41 of the metal plates 2 and 4, so that a positive-locking composite of the individual components is obtained. The textile layer 7 is bonded on. The hollow spaces 9 of the egg-box structure 3 are filled with air.

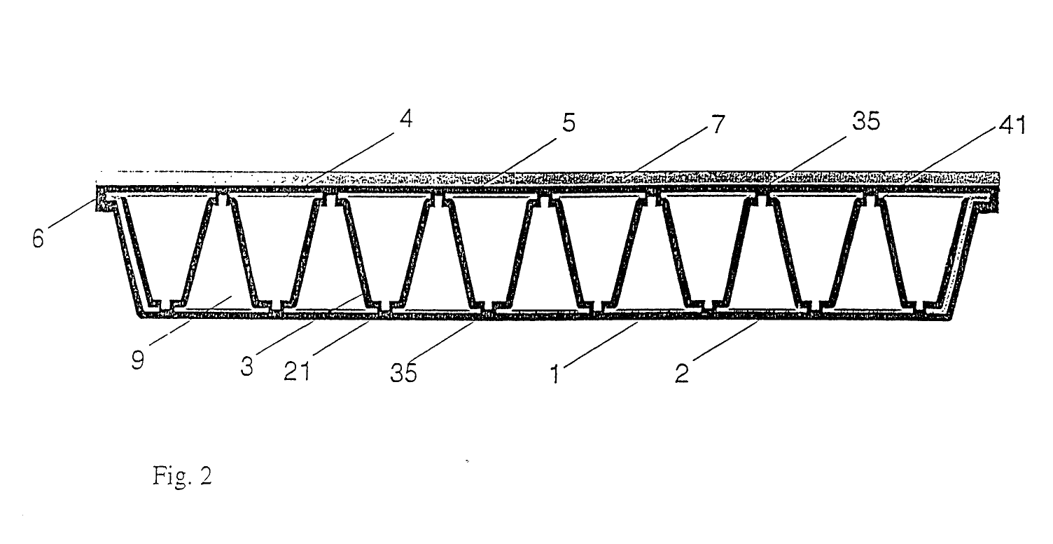

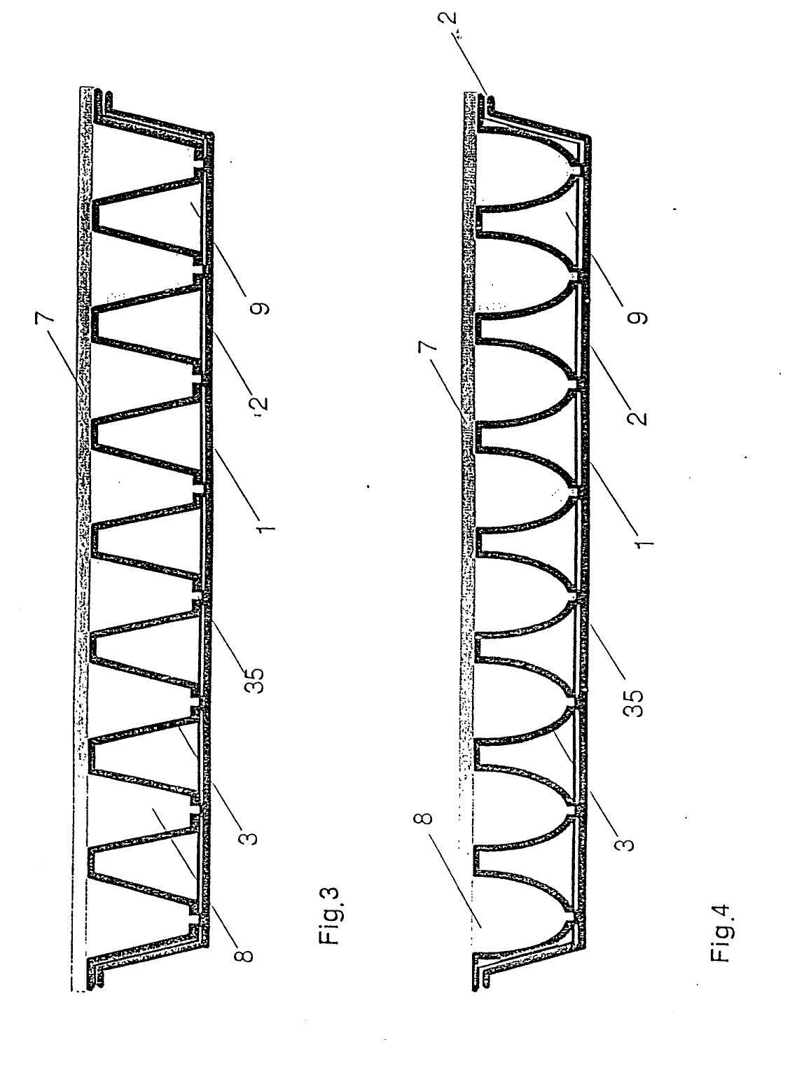

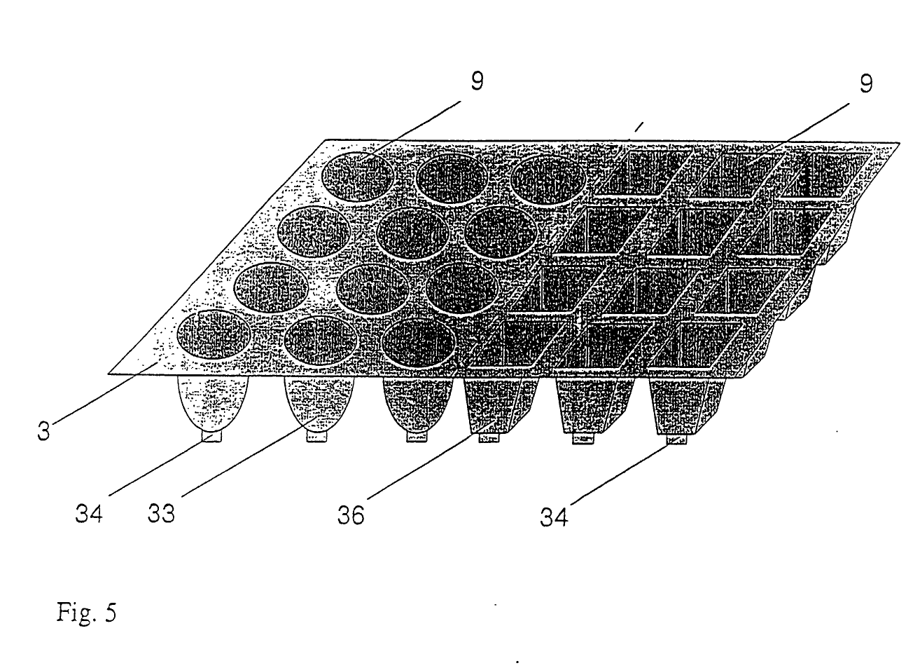

In FIGS. 3 and 4 the hollow spaces of the egg-box structure 3 are filled on one side with a foam 8. FIGS. 3 and 4 likewise show modified forms of the sandwich structure of FIG. 1. The egg-box structure is however executed on only one side. A representation of the egg-box structures according to FIGS. 3 and 4 is given in FIG. 5. The egg-box structure 3 is furnished with ellipsoid or truncated pyramid-shaped hollow spaces 9, which are formed by domes 36 and are integrally molded with the connecting elements 34.

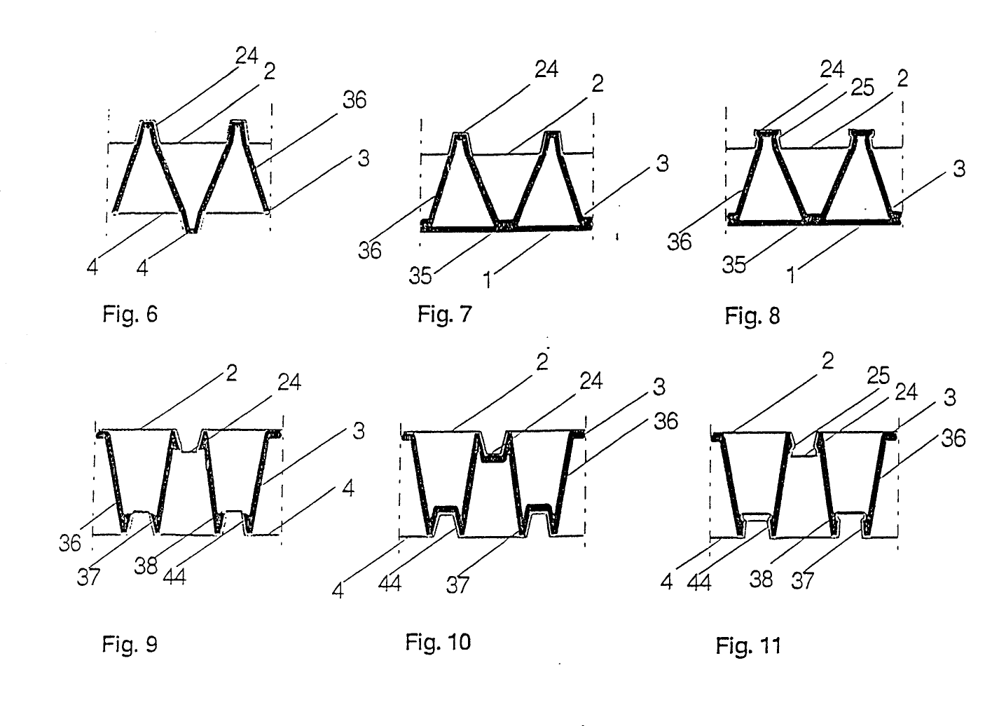

Cut-out modifications of the sandwich structure of FIG. 1. are reproduced in FIGS. 6 to 11. Various connection possibilities between the metal plates 2 and 4 and the egg-box structure 3 are represented here.

In FIG. 6 the two nubbed metal plates 2 and 4 are connected to the egg-box structure due to the fact that the ends of the domes of the egg-box structure 3 fit into the nubs 24 and 44 of the metal plates 2 and 4. The connection may be supported by means of an adhesive.

FIG. 7 shows a sandwich structure consisting of a plastic plate 1, an egg-box structure 3 and a nubbed metal plate 2.

The lightweight part according to FIG. 8 shows a similar layout to that of FIG. 7. However, in FIG. 8 the nubs 24 of the metal plate 2 are connected positively to the egg-box structure 3 by a bead 25.

The views in FIGS. 9 to 11 show connections of metal plates 2 and 4 to an intermediate egg-box structure 3. In these examples the nubs 24 and 44 are shaped inwardly towards the egg-box structure 3. The egg-box structure 3 likewise comprises in the domes 36 depressions 37 that are directed inwards. In FIGS. 9 and 11 these depressions are provided with an opening 38 through which the nubs 24 and 44 of the metal plates 2 and 4 project. In FIG. 1 the nubs 24 and 44 are provided with a bead 25 which ensures a positive-locking connection oblique to the plate plane of the lightweight part between the components 2, 4 and 3.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A lightweight composite article comprising:
(a) two substantially opposed plates, at least one of said plates is a metal plate; and
(b) a support structure of thermoplastic material interposed between said plates, said support structure defining a plurality of hollow spaces,
wherein each of said plates is fixedly attached to said support structure by means of a plurality of anchors, said anchors being distributed substantially uniformly over the surface of each of said plates.

2. The lightweight composite article of claim 1 wherein said support structure is substantially symmetrical.

3. The lightweight composite article of claim 1 wherein said support structure is substantially continuous.

4. The lightweight composite article of claim 1 wherein said support structure is selected from at least one of ribbed support structures and egg-box support structures.

5. The lightweight composite article of claim 1 wherein at least a portion of the hollow spaces of said structure are filled with a foam.

6. The light weight composite article of claim 1 wherein said anchors are selected from:
(i) each of said plates has a plurality of at least one of perforations and recesses, and said support structure has a plurality of joining elements extending therefrom, at least some of said joining elements extending through at least some of said perforations and into at least some of said recesses, thereby anchoring each of said plates to said support structure;
(ii) said support structure has a plurality of at least one of perforations and recesses, and each of said plates has a plurality of joining elements extending therefrom, at least some of said joining elements extending through at least some of said perforations and into at least some of said recesses of said support structure, thereby anchoring each of said plates to said support structure; and
(iii) a combination of (i) and (ii).

7. The lightweight composite article of claim 1 wherein the thermoplastic plastic of said support structure is selected from at least one of polyamide, polyester, polyolefin, styrene copolymer, polycarbonate, polyphenylene oxide, polyphenylene sulfide, polyimide, polyvinyl chloride, thermoplastic polyurethane, PSO and PEEK.

8. The lightweight composite article of claim 1 wherein the metal of the metal plate is selected from at least one of steel, aluminium, magnesium, and metal alloys comprising at least one of steel, aluminium and magnesium.

9. The lightweight composite article of claim 1 wherein one plate is a composite of plastic and fiber.

10. The lightweight composite article of claim 1 further comprising at least one plastic plate abutting said metal plate.

11. The lightweight composite article of claim 1 wherein said lightweight composite article has an edge region, and said plates are connected one to the other in said edge region.

12. The lightweight composite article of claim 11 wherein said plates are connected one to the other in said edge region by means of crimping, and a thermoplastic material is interposed between said plates in the crimped edge region.

13. An article of manufacture comprising the lightweight composite article of claim 1.

14. The article of manufacture of claim 13 wherein said article of manufacture is selected from at least one of automotive parts, appliance parts and construction materials.
